(19) United States
(12) Patent Application Publication
(10) Pub. No.: US 2006/0238756 A1
(43) Pub. Date: Oct. 26, 2006

(54) Fast spectral confocal imager

(76) Inventors: Gregory H. Bearman, Pasadena, CA (US); Daniel W. Wilson, Montrose, CA (US); Scott E. Fraser, La Canada, CA (US)

Correspondence Address: CHRISTIE, PARKER & HALE, LLP, PO BOX 7068, PASADENA, CA, 91109-7068, US

(21) Appl. No.: 11/351,558

(22) Filed: Feb. 10, 2006

Related U.S. Application Data
(60) Provisional application No. 60/651,818, filed on Feb. 10, 2005.

(51) Int. Cl. G01J 3/30; G01J 3/28

(52) U.S. Cl. 356/318; 356/328

(57) ABSTRACT

Fast confocal spectral imagers are provided. A fast confocal spectral imager according to the invention includes a spectral imager coupled to a fast confocal microscope. A laser is provided for generating laser light, which passes through scanning optics which are configured to scan a line- or slit-shaped region of a specimen at a given time. The light then passes through an objective lens and excites fluorescent dyes applied to the specimen, causing the dyes to fluoresce at respective emission spectra. The fluorescence radiated by the excited dyes then passes back through the scanning optics and is directed to a fixed slit that functions as an entrance slit for a spectral imager. The spectral imager receives the fluorescence and separates it into wavelength bands. The wavelength and position across the slit-shaped region of the specimen for each wavelength band are then recorded.

### CROSS-REFERENCE TO RELATED APPLICATION

This application claims priority to and the benefit of U.S. Provisional Patent Application No. 60/651,818 entitled “FAST SPECTRAL CONFOCAL IMAGER,” filed on Feb. 10, 2005 in the United States Patent and Trademark Office, the entire content of which is incorporated herein by reference.

### STATEMENT REGARDING FEDERALLY SPONSORED RESEARCH OR DEVELOPMENT

The invention described herein was made in the performance of work under a NASA contract, and is subject to the provisions of Public Law 96-517 (35 U.S.C. § 202) in which the Contractor has elected to retain title.

### FIELD OF THE INVENTION

The present invention is directed to fast confocal spectral imagers in which spectral imagers are coupled to slit-image confocal microscopes.

### BACKGROUND OF THE INVENTION

In fluorescence microscopy, a specimen is examined by first treating it with one or more fluorescent dyes (markers) that selectively attach to portions of the specimen. Illuminating the dyes with light of a particular wavelength causes the dyes to fluoresce at light of another wavelength. This fluorescent light is then examined through a microscope to identify those portions of the specimen to which the respective dyes attached. The dyes are typically illuminated using a laser, which outputs relatively intense light over a narrow spectrum to selectively excite particular dyes.

In confocal fluorescence microscopy, a scanning microscope is used which images a single point of the specimen at a given time. A complete three-dimensional image of the specimen is obtained by scanning the specimen point by point until the entire area of interest is imaged. While this technique provides images of good quality, the point by point scanning process takes a considerable amount of time to complete. In addition, conventional confocal microscopes do not provide other useful information, such as spectral data. Accordingly, a need exists for a fast confocal microscope capable of providing spectral information.

### SUMMARY OF THE INVENTION

The present invention is directed to a fast confocal spectral imager in which a spectral imager is coupled to a fast confocal microscope. The fast confocal spectral imagers of the present invention include a laser for generating laser light. The laser light passes through scanning optics which are configured to scan a slit or line of a specimen at a given time. The light then passes through an objective lens and excites the specimen, causing the specimen to autofluoresce at different wavelengths. Alternatively, fluorescent dyes can be applied to the specimen prior to excitation. In such an embodiment, the laser light would excite the fluorescent markers, which would then fluoresce at respective wavelengths. The fluorescence radiated by the specimen (or the fluorescent markers in the specimen) then passes back through the scanning optics and is directed to a fixed slit that functions as an entrance slit for a spectral imager.

Any imaging spectrometer capable of spreading a slit image across a 2D detector can be used as the spectral imager. These slit-imaging spectrometers can have any suitable structure. For example, the spectral imager may comprise a Czemy-Turner spectrometer or a single-element spectrometer. In one embodiment, the spectral imager comprises an Offner spectrometer operating in a pushbroom fashion (i.e., the spectrometer collects spectral data for an entire slit or line at once). Such a spectrometer comprises a first concave mirror and second convex mirror arranged concentrically. A convex grating is positioned on the convex mirror and operates to separate the fluorescence into wavelengths bands. When the fluorescence enters the spectrometer it is directed to a first region of the concave mirror which reflects the fluorescence to the grating on the convex mirror. The grating disperses the fluorescence onto a charge coupled device (CCD) which records each element of the separated fluorescence simultaneously without the use of electromechanical components. Specifically, the CCD or other two-dimensional array sensor records an image of the slit which is spectrally spread across one dimension of the sensor. A digital camera captures the light and uses the CCDs to convert the light photons to electrons, which are then counted and recorded as digital values. A computer processes the digital values from the camera and displays an image of the specimen on a monitor.

The fast confocal spectral imagers of the present invention in which a spectral imager is coupled to a confocal microscope improve the accuracy and spectral resolution of the image produced.

### BRIEF DESCRIPTION OF THE DRAWINGS

These and other features and advantages of the present invention will be better understood by reference to the following detailed description when considered in conjunction with the accompanying drawings in which:

FIG. 1 is a schematic depicting one embodiment of a fast confocal spectral imager according to one embodiment of the present invention;

FIG. 2 is a schematic depicting one embodiment of a spectral imager for use in the fast confocal spectral imager of FIG. 1; and

FIG. 3 is a schematic depicting another embodiment of a spectral imager for use in the fast confocal spectral imager of FIG. 1.

### DETAILED DESCRIPTION OF THE INVENTION

To image a specimen 22 using a fast confocal spectral imager 10 according to the present invention, at least one excitable fluorescent dye (marker) is first applied to the specimen. In one embodiment, a plurality of markers are applied to the specimen. Upon excitation of the markers, the markers fluoresce and each marker emits light having a different wavelength. Alternatively, no fluorescent markers are used, and light directed at the specimen causes the specimen to autofluoresce, radiating fluorescence at different wavelengths.

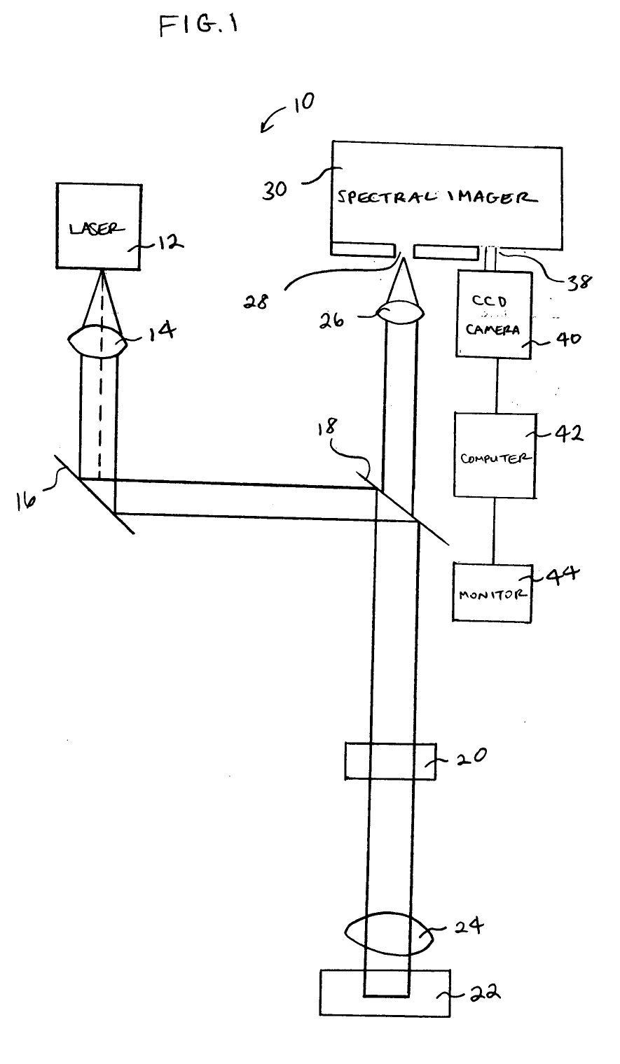

As shown in FIG. 1, in a fast confocal spectral imager 10 according to one embodiment of the present invention, a laser 12 generates laser light. The light emitted by the laser 12 is focused by a lens 14 onto a short pass dichroic mirror 16, which selectively reflects light according to wavelength. The dichroic mirror 16 is selected such that it reflects the light emitted by the laser 12 but allows light of a different wavelength (e.g. the fluorescence radiated from the autofluorescence of the specimen or from the excited dyes in the specimen) to pass.

The laser light reflected by the dichroic mirror 16 is directed to scanning optics 20 via a scanning mirror 18. The scanning optics 20 may include any suitable structure capable of directing the reflected light for scanning the specimen 22 by the laser light. Conventional confocal microscopes utilize disks (sometimes known as Nipkow's disks) having multiple pinholes arranged either randomly or in a specified pattern that are rotated or otherwise moved for focusing a single point source of light at a time on a corresponding region of the specimen. In contrast, the scanning optics 20 according to the present invention are configured to scan an entire line- or slit-shaped region of the specimen 22 at a time. This feature enables the imager 10 to complete imaging much faster than conventional confocal microscopes.

The directed light from the scanning optics 20 is imaged by an objective lens 24 onto or into a corresponding slit-shaped region of the specimen 22. In one embodiment, the laser light excites the fluorescent dyes in the region of the specimen where the light is directed such that those dyes fluoresce and emit light having respective emission spectra. In another embodiment, the laser light causes the slit-shaped region of the specimen to autofluoresce, radiating fluorescence and emitting light having different emission spectra. The fluorescence radiated by either the autofluorescence of the specimen of by the excited dyes is focused by the objective lens 24, passes through the scanning optics 20, is directed to the dichroic mirror 16 by the scanning mirror 18, and passes through the dichroic mirror 16. The fluorescence is then focused by a lens 26 and directed to a fixed slit 28 where the light enters a spectral imager 30.

Although described with reference to one exemplary beam path and microscope construction, it is understood that any beam path and microscope construction can be used. Specifically, any known confocal beam path and confocal microscope can be used. However, because the fast spectral confocal imagers of the present invention involve scanning a slit-shaped region of the specimen, confocal microscopes utilizing Nipkow's disks are not ideal.

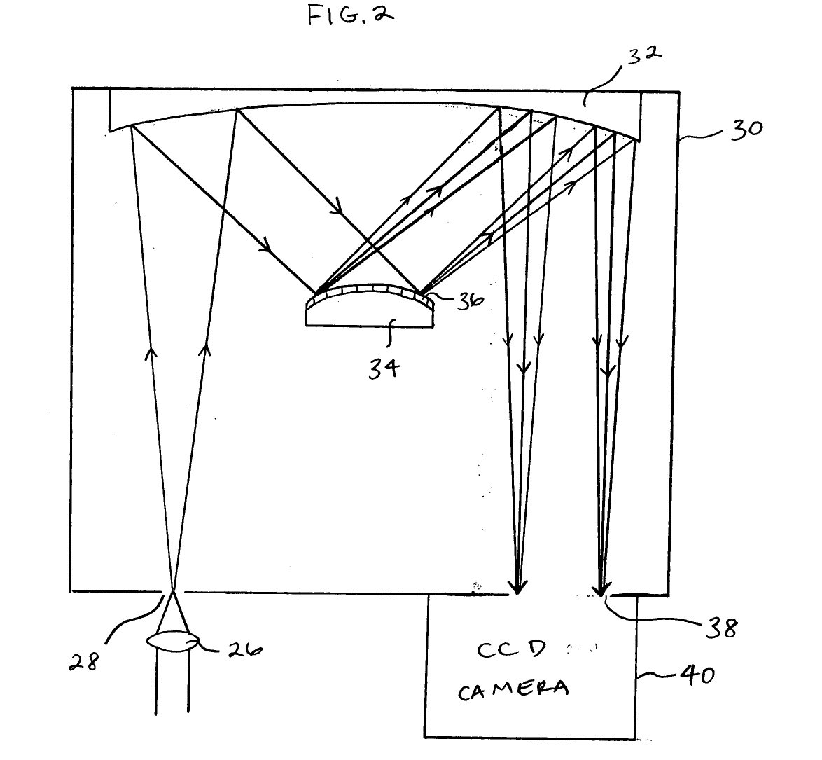

The spectral imager 30 may have any suitable structure. For example, the spectrometer may be a Czerny-Turner spectrometer. Alternatively, the spectrometer comprises a single element spectrometer, such as that described in Wilson, D., et al., “Binary optic reflection grating for an imaging spectrometer,” Diffractive and Holographic Optics Technology III, SPIE Proceedings, vol. 2689 (February 1996), the entire content of which is incorporated herein by reference. In one embodiment, as shown in FIG. 2, the spectral imager 30 is a concentric spectrometer operating in a pushbroom fashion (i.e., the spectrometer collects spectral data for an entire slit or line at once). Nonlimiting examples of spectrometers suitable for use with the imagers of the present invention include those disclosed in Mouroulis, P., et al., “Pushbroom imaging spectrometer with high spectroscopic data fidelity: experimental demonstration,” Opt. Engineering, 39, p. 808 (2000) and Mertz, L., “Concentric Spectrographs,” Appl. Opt., 16, pp. 3122-3124 (1977), the entire contents of which are incorporated herein by reference.

The small size and high performance of Offner spectrometers make them particularly suitable for this application. Such an Offner type spectrometer includes a first concave mirror 32 and a second convex mirror 34 positioned concentrically relative to each other. A grating 36 is positioned on the convex mirror 34. The light passing through the slit 28 enters the spectral imager 30 and is directed from the slit 28 to a first region of the concave mirror 32. The light is then directed to the grating 36 on the convex mirror 34. The grating 36 separates the light into wavelength bands which are reflected back toward a second region of the concave mirror 32. The second region of the concave mirror 32 is different in position from the first region. From the second region of the concave mirror 32, the separated fluorescence passes through an exit slit 38 in the spectral imager 30 to a CCD camera 40.

The CCD camera 40 comprises an array of charge coupled devices (CCDs) (not shown) which record each element of the separated fluorescence simultaneously without the use of electromechanical components. Although described with reference to CCDs, it is understood that any two-dimensional photodetector technology can be used (e.g. CMOS, CID, etc.). The CCDs record the wavelength and position across the scanned line of each spectrum received from the spectral imager. Specifically, the two-dimensional CCDs record the two-dimensional image of the slit in one dimension and the wavelength in the other dimension. A digital camera captures the light and uses the CCDs to convert the light photons to electrons, which are then counted and recorded as digital values. A computer 42 processes the digital values from the camera and displays an image of the specimen on a monitor 44.

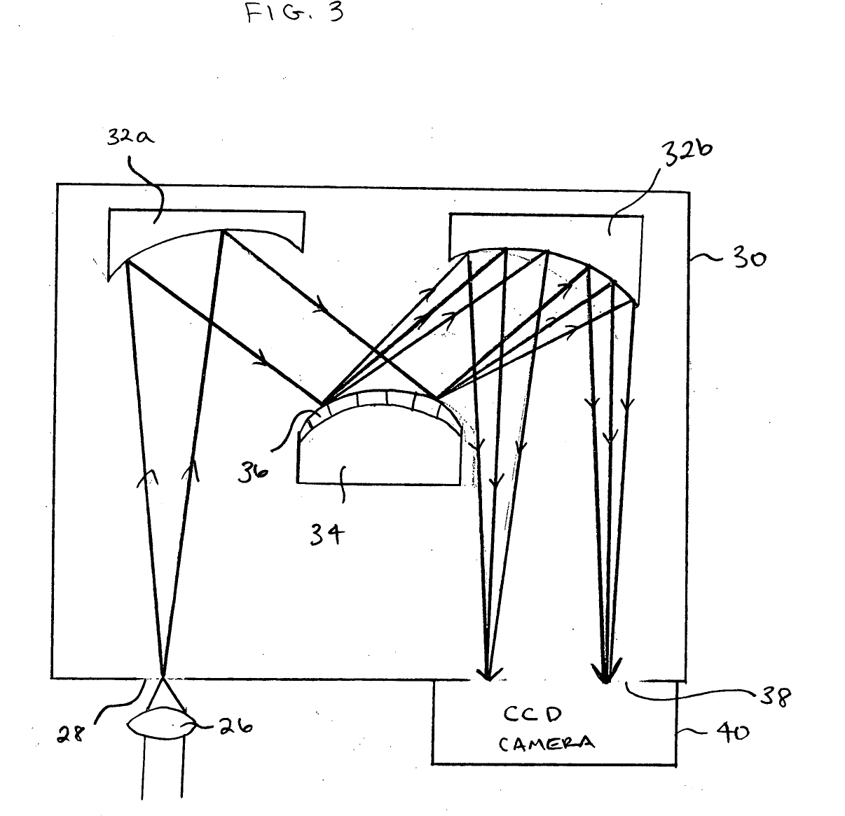

In an alternative embodiment, as shown in FIG. 3, the Offner type spectral imager 30 includes two concave mirrors 32a and 32b, a convex mirror 34 and a grating 36 positioned on the convex mirror 34. In this embodiment, the two concave mirrors 32a and 32b are positioned generally linearly relative to each other, such that the light entering the spectral imager 30 is directed toward the first concave mirror 32a, and the separated fluorescence reflected by the grating 36 is directed toward the second concave mirror 32b.

The grating 36 used in the spectral imager 30 can have any suitable structure and be constructed in any suitable manner. Suitable gratings for use with the spectral imagers of the present invention include those described in Mouroulis, P., et al., “Convex grating types for concentric imaging spectrometers,” Appl. Optics, vol. 37, pp. 7200-7208 (Nov. 1, 1998) and Wilson, D. W., et al., “Recent advances in blazed grating fabrication by electron-beam lithography,” Current Developments in Lens Design and Optical Engineering IV, Proc. SPIE 5173, pp. 115-126 (2003), the entire contents of which are incorporated herein by reference. In one embodiment, the grating 36 is a high-efficiency blazed convex grating fabricated by electron-beam lithography. Such gratings can achieve very high diffraction efficiency, for example 90% at the blaze wavelength for a sawtooth groove profile. In another embodiment, the grating is a structured groove grating fabricated by electron-beam lithography, where the groove shape is designed to achieve a desired efficiency versus wavelength response. Structured groove gratings can be designed to have relatively flat spectral efficiency over the 400-700 nm range, unlike conventional sawtooth gratings which have sharp efficiency peaks at the blaze wavelength and die off rapidly at shorter wavelengths. Alternatively, structured groove gratings can be optimized to maximize the signal for specific fluorophores. Structured groove gratings suitable for use with the present invention are described in co-pending U.S. patent application Ser. No. 11/198,869, filed on Aug. 4, 2005, entitled “STRUCTURED GROOVE DIFFRACTION GRATING AND METHOD FOR CONTROL AND OPTIMIZATION OF SPECTRAL EFFICIENCY,” the entire content of which is incorporated herein by reference.

The use of an Offner type spectrometer with the fast confocal microscope in accordance with the present invention provides a low cost and compact solution for relaying the slit image. In addition, the use of a slit-imaging confocal microscope with an Offner spectrometer significantly reduces both barrel and pincushion distortion, thereby improving the spectral results.

The preceding description has been presented with reference to certain exemplary embodiments of the present invention. However, workers skilled in the art and technology to which this invention pertains will appreciate that alterations and changes to the described embodiments may be practiced without meaningfully departing from the principal, spirit and scope of this invention. Accordingly, the foregoing description should not be read as pertaining only to the precise embodiments described and illustrated in the accompanying drawings, but rather should be read consistent with and as support for the following claims which are to have their fullest and fairest scope.

What is claimed is:

1. A fast confocal spectral imager for imaging a specimen, the fast confocal spectral imager comprising:
a laser for generating laser light;
means for directing the laser light across a slit-shaped region of the specimen causing the slit-shaped region of the specimen to autofluoresce, radiating a slit-shaped beam of fluorescence as a result;
a spectral imager for receiving the slit-shaped beam of fluorescence from the specimen, wherein the spectral imager separates the fluorescence wavelength bands; and
a two-dimensional sensor which records a wavelength in one dimension and a two-dimensional position in the second dimension.

2. The fast confocal spectral imager of claim 1, wherein the means for directing the laser light comprises a scanning optic configured to scan a slit-shaped region of the specimen.

3. The fast confocal spectral imager of claim 1, wherein the spectral imager comprises an Offner type spectrometer.

4. The fast confocal spectral imager of claim 3, wherein the Offner type spectrometer comprises a first concave mirror, a second convex mirror, and a convex grating positioned on the convex mirror, wherein the first and second mirrors are positioned concentrically relative to each other.

5. The fast confocal spectral imager of claim 4, wherein the grating is a structured groove grating.

6. The fast confocal spectral imager of claim 3, wherein the Offner type spectrometer comprises first and second concave mirrors, a third convex mirror and a convex grating positioned on the convex mirror, wherein the first and second concave mirrors are positioned generally linearly relative to each other and concentrically relative to the convex mirror.

7. The fast confocal spectral imager of claim 6, wherein the grating is a structured groove grating.

8. A fast confocal spectral imager for imaging a specimen having at least one excitable marker, the fast confocal spectral imager comprising:
a laser for generating laser light;
means for directing the laser light across a slit-shaped region of the specimen to excite the at least one marker in the slit-shaped region of the specimen, whereby the at least one marker in the slit-shaped region of the specimen radiates slit-shaped beam of light as a result;
a spectral imager for receiving the slit-shaped beam of fluorescence from the specimen, wherein the spectral imager separates the fluorescence into wavelength bands; and
a two-dimensional sensor which records a wavelength in one dimension and a two-dimensional position in the second dimension.

9. The fast confocal spectral imager of claim 8, wherein the means for directing the laser light comprises a scanning optic configured to scan a slit-shaped region of the specimen.

10. The fast confocal spectral imager of claim 8, wherein the spectral imager comprises an Offner type spectrometer.

11. The fast confocal spectral imager of claim 10, wherein the Offner type spectrometer comprises a first concave mirror, a second convex mirror, and a convex grating positioned on the convex mirror, wherein the first and second mirrors are positioned concentrically relative to each other.

12. The fast confocal spectral imager of claim 11, wherein the grating is a structured groove grating.

13. The fast confocal spectral imager of claim 10, wherein the Offner type spectrometer comprises first and second concave mirrors, a third convex mirror and a convex grating positioned on the convex mirror, wherein the first and second concave mirrors are positioned generally linearly relative to each other and concentrically relative to the convex mirror.

14. The fast confocal spectral imager of claim 13, wherein the grating is a structured groove grating.

15. The fast confocal spectral imager of claim 1, wherein the specimen has a plurality of excitable markers.

16. A method of imaging a specimen comprising:
applying at least one excitable marker to the specimen;
focusing light on a slit-shaped region of the specimen from a laser to excite the at least one marker in the slit-shaped region and cause fluorescence to be radiated by the at least one marker in the slit-shaped region;
separating the fluorescence into wavelength bands using a spectral imager; and
recording a wavelength and two-dimensional position across the slit-shaped region of each spectra.

17. The method of claim 16, wherein the spectral imager comprises an Offner type spectrometer.

18. The method of claim 17, wherein the Offner type spectrometer comprises a first concave mirror, a second convex mirror, and a convex grating positioned on the convex mirror, wherein the first and second mirrors are positioned concentrically relative to each other.

19. The method of claim 17, wherein the Offner type spectrometer comprises first and second concave mirrors, a third convex mirror and a convex grating positioned on the convex mirror, wherein the first and second concave mirrors are positioned generally linearly relative to each other and concentrically relative to the convex mirror.

20. A method of imaging a specimen comprising:
focusing light on a slit-shaped region of the specimen from a laser to cause the slit-shaped region to radiate fluorescence;
separating the fluorescence into wavelength bands using a spectral imager; and
recording a wavelength and two-dimensional position across the slit-shaped region of each spectra.

21. The method of claim 20, wherein the spectral imager comprises an Offner type spectrometer.

22. The method of claim 21, wherein the Offner type spectrometer comprises a first concave mirror, a second convex mirror, and a convex grating positioned on the convex mirror, wherein the first and second mirrors are positioned concentrically relative to each other.

23. The method of claim 21, wherein the Offner type spectrometer comprises first and second concave mirrors, a third convex mirror and a convex grating positioned on the convex mirror, wherein the first and second concave mirrors are positioned generally linearly relative to each other and concentrically relative to the convex mirror.
